(19) United States
(12) Patent Application Publication
(10) Pub. No.: US 2016/0059322 A1
(43) Pub. Date: Mar. 3, 2016

(54) SECOND STAGE DRILL BIT

(71) Applicants: SETH BRESLAW, HILLSDALE, NJ (US); MARK HAFFNER, WANTAGH, NY (US)

(72) Inventors: SETH BRESLAW, HILLSDALE, NJ (US); MARK HAFFNER, WANTAGH, NY (US)

(21) Appl. No.: 14/472,690

(22) Filed: Aug. 29, 2014

(51) Int. Cl. B23B 51/04

(52) U.S. Cl. CPC B23B 51/0473; B23B 2251/428; B23B 2251/606; B23B 2240/00

(57) ABSTRACT

A second stage drill bit includes a main body, a connection adapter, and a plurality of teeth. The connection adapter is disposed on an upper portion of the main body. The connection adapter is configured to detachably couple the second stage drill bit to a drilling device and to detachably couple the second stage drill bit to a primary drill bit. The plurality of teeth are disposed on a bottom edge of the main body. The plurality of teeth are configured to penetrate a surface during a drilling process. Upon coupling the second stage drill bit to the drilling device and the primary drill bit, the second stage drill bit is disposed in an area between the drilling device and the primary drill bit, and a portion of the primary drill bit is surrounded by the main body.

### BACKGROUND

1. Technical Field

Exemplary embodiments of the present invention relate to a drill bit, and more particularly, to a second stage drill bit configured to be attached to a drilling device.

2. Discussion of Related Art

A core hole refers to a hole in which a cylindrical portion of material is removed from a surface. Core holes are typically drilled using core drills, and may be used in a variety of different projects including, for example, plumbing projects, electrical projects, HVAC projects, etc.

In certain situations, a core hole including two different sized holes may be required. For example, when installing a pipe into a core hole, a first hole having a first size that accommodates the pipe may first be drilled, and a second hole having a second, different size from the first hole that accommodates a connecting portion at the end of the pipe may then be drilled around the first hole. Accordingly, a first drilling process using a first drill bit attached to the core drill to drill the first hole may be performed, and subsequently, a second, separate drilling process using a second drill bit attached to the core drill to drill the second hole may then be performed.

### SUMMARY

According to an exemplary embodiment of the present invention, a second stage drill bit includes a main body, a connection adapter, and a plurality of teeth. The connection adapter is disposed on an upper portion of the main body. The connection adapter is configured to detachably couple the second stage drill bit to a drilling device and to detachably couple the second stage drill bit to a primary drill bit. The plurality of teeth are disposed on a bottom edge of the main body. The plurality of teeth are configured to penetrate a surface during a drilling process. Upon coupling the second stage drill bit to the drilling device and the primary drill bit, the second stage drill bit is disposed in an area between the drilling device and the primary drill bit, and a portion of the primary drill bit is surrounded by the main body.

In an exemplary embodiment, a size of the main body is larger than a size of the primary drill bit.

In an exemplary embodiment, the size of the main body corresponds to a diameter of the main body and a size of the primary drill bit corresponds to a diameter of the primary drill bit.

In an exemplary embodiment, the connection adapter includes a plurality of set screws extending through a sidewall of the connection adapter and into an inner chamber of the connection adapter. The inner chamber is shaped and dimensioned to receive the primary drill bit through the main body, and the plurality of set screws detachably couple the second stage drill bit to the primary drill bit upon the plurality of set screws contacting the primary drill bit in the inner chamber in response to being tightened.

In an exemplary embodiment, the connection adapter includes a pass-through aperture configured to permit a drill bit connecting portion of the drilling device to extend through the pass-through aperture and detachably couple to the primary drill bit through the connection adapter.

In an exemplary embodiment, the drill bit connecting portion of the drilling device detachably couples to the primary drill bit through the connection adapter via cooperating threaded connections respectively disposed on the connection portion of the drilling device and the primary drill bit.

In an exemplary embodiment, the connection adapter is shaped and dimensioned to be received into a chuck of the drilling device to detachably couple the second stage drill bit to the drilling device.

In an exemplary embodiment, the connection adapter includes a threaded portion disposed on an inner sidewall of the connection adapter facing an inner chamber of the connection adapter. The inner chamber is shaped and dimensioned to receive a threaded adapter connected to the drilling device, and the threaded portion of the connection adapter includes a thread pattern that interlocks with the threaded adapter to detachably couple the second stage drill bit to the drilling device.

In an exemplary embodiment, the drilling device is a large scale drilling machine.

In an exemplary embodiment, the drilling device is a handheld drilling device.

According to an exemplary embodiment of the present invention, a second stage drill bit includes a connection adapter, a bit carrier component, and a second stage cutting component. The connection adapter is disposed at an upper portion of the second stage drill bit. The connection adapter is configured to detachably couple the second stage drill bit to a drilling device and to detachably couple the second stage drill bit to a primary drill bit. The bit carrier component is coupled to the connection adapter. The second stage cutting component is coupled to the bit carrier component. The second stage cutting component includes a plurality of teeth disposed on a bottom edge of the second stage cutting component and the plurality of teeth are configured to penetrate a surface during a drilling process. Upon coupling the second stage drill bit to the drilling device and the primary drill bit, the second stage drill bit is disposed in an area between the drilling device and the primary drill bit, and a portion of the primary drill bit is surrounded by a portion of the second stage drill bit.

In an exemplary embodiment, a size of the second stage cutting component is larger than a size of the primary drill bit.

In an exemplary embodiment, the size of the second stage cutting component corresponds to a diameter of the second stage cutting component and a size of the primary drill bit corresponds to a diameter of the primary drill bit.

In an exemplary embodiment, the bit carrier component is permanently coupled to the connection adapter, and the second stage cutting component is detachably coupled to the bit carrier component.

According to an exemplary embodiment of the present invention, a second stage drill bit includes a connection adapter, a bit carrier component, and a second stage cutting component. The connection adapter is disposed at an upper portion of the second stage drill bit. The connection adapter is configured to detachably couple the second stage drill bit to a drilling device and to detachably couple the second stage drill bit to a primary drill bit. The connection adapter includes a plurality of set screws extending through a sidewall of the connection adapter and into an inner chamber of the connection adapter. The inner chamber is shaped and dimensioned to receive the primary drill bit through the main body, and the plurality of set screws detachably couple the second stage drill bit to the primary drill bit upon the plurality of set screws contacting the primary drill bit in the inner chamber in response to being tightened. The inner chamber forms a pass-through aperture configured to permit a drill bit connecting portion of the drilling device to extend through the pass-through aperture and detachably couple to the primary drill bit through the connection adapter. The bit carrier component is permanently coupled to the connection adapter. The second stage cutting component is detachably coupled to the bit carrier component. The second stage cutting component includes a plurality of teeth disposed on a bottom edge of the second stage cutting component and the plurality of teeth are configured to penetrate a surface during a drilling process. Upon coupling the second stage drill bit to the drilling device and the primary drill bit, the second stage drill bit is disposed in an area between the drilling device and the primary drill bit, and a portion of the primary drill bit is surrounded by a portion of the second stage drill bit.

### BRIEF DESCRIPTION OF THE DRAWINGS

The above and other features of the present invention will become more apparent by describing in detail exemplary embodiments thereof with reference to the accompanying drawings, in which:

FIG. 1A shows a side view of a second stage drill bit according to an exemplary embodiment of the present invention.

FIG. 1B shows a side view of the second stage drill bit detachably coupling to a core drilling machine and a core drill bit according to an exemplary embodiment of the present invention.

FIG. 1C shows a side view of the second stage drill bit detachably coupling to a standard drilling device and a standard drill bit according to an exemplary embodiment of the present invention.

FIG. 1D shows a side view of the second stage drill bit detachably coupled to a standard drill bit.

FIG. 2 is a side view showing a core hole drilled using the second stage drill bit shown in FIGS. 1A to 1D according to an exemplary embodiment of the present invention.

FIG. 3 is a top view of the second stage drill bit shown in FIGS. 1A to 1D according to an exemplary embodiment of the present invention.

### DETAILED DESCRIPTION OF THE EXEMPLARY EMBODIMENTS

Exemplary embodiments of the present invention will be described more fully hereinafter with reference to the accompanying drawings. Like reference numerals may refer to like elements throughout the accompanying drawings.

Exemplary embodiments of the present invention provide a drill bit configured to be used with a standard drilling device, including a standard core drilling device, and capable of improving the efficiency of drilling holes in a variety of settings. The drill bit may be referred to herein as a second stage drill bit. The second stage drill bit drills a secondary hole during a drilling process. As will be described in further detail herein, the second stage drill bit is designed to allow for a plurality of holes (e.g., two holes), including holes having different sizes, to be drilled using a single drilling process (e.g., a single core drilling process). The second stage drill bit may be made of a variety of different materials including, for example, a metal such as steel, or a combination of different materials including, for example, steel, carbon steel, high speed steel (HSS), cobalt, magnesium, tungsten, titanium, chromium, vanadium, molybdenum, zirconium, diamond chips, etc.

The second stage drill bit according to exemplary embodiments of the present invention may be used in any setting in which a drilling device is used to drill at least two overlapping holes of different sizes, including, for example, a core hole. A core hole refers to a hole in which a cylindrical portion of material is removed from a surface. Core holes may be used in a variety of different projects including, for example, plumbing projects, electrical projects, HVAC projects, etc. Although exemplary embodiments of the present invention may be described herein with specific reference to drilling holes for the placement of pipes in a plumbing setting, it is to be understood that exemplary embodiments of the present invention are not limited thereto. For example, the exemplary embodiments described herein may be utilized in any one of a variety of settings in which overlapping holes of different sizes are to be drilled. The second stage drill bit may be used to drill through a variety of surfaces including, for example, concrete, wood, drywall, etc.

Spatially relative terms, such as “beneath”, “below”, “lower”, “under”, “above”, “upper”, etc., may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. It will be understood that elements shown in the drawings may not be drawn to scale.

It will be further understood that when an element is referred to as being “on”, “connected to”, “coupled to”, or “adjacent to” another element, it can be directly on, connected, coupled, or adjacent to the other element, or intervening elements may be present. It will also be understood that when an element is referred to as being “between” two elements, it can be the only element between the two elements, or one or more intervening elements may also be present.

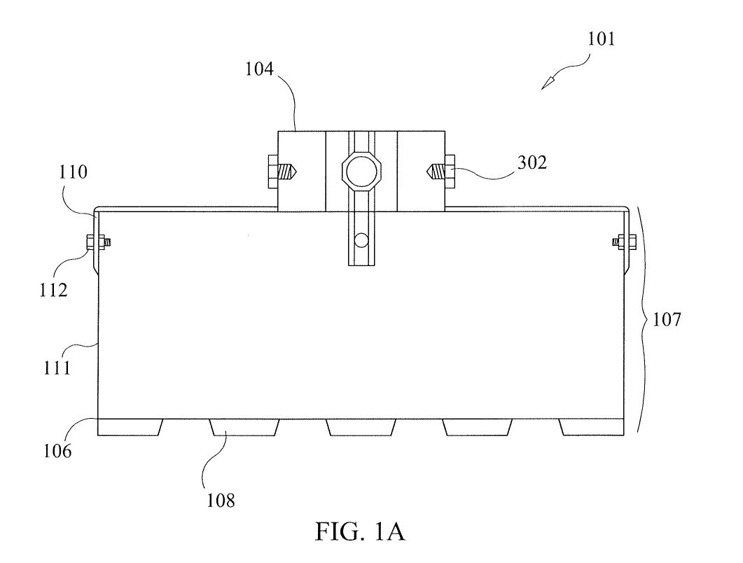

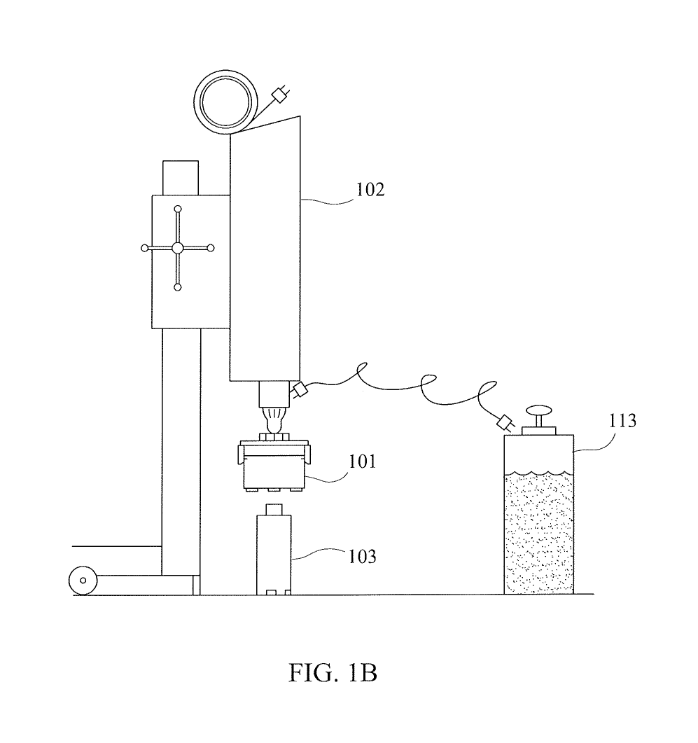

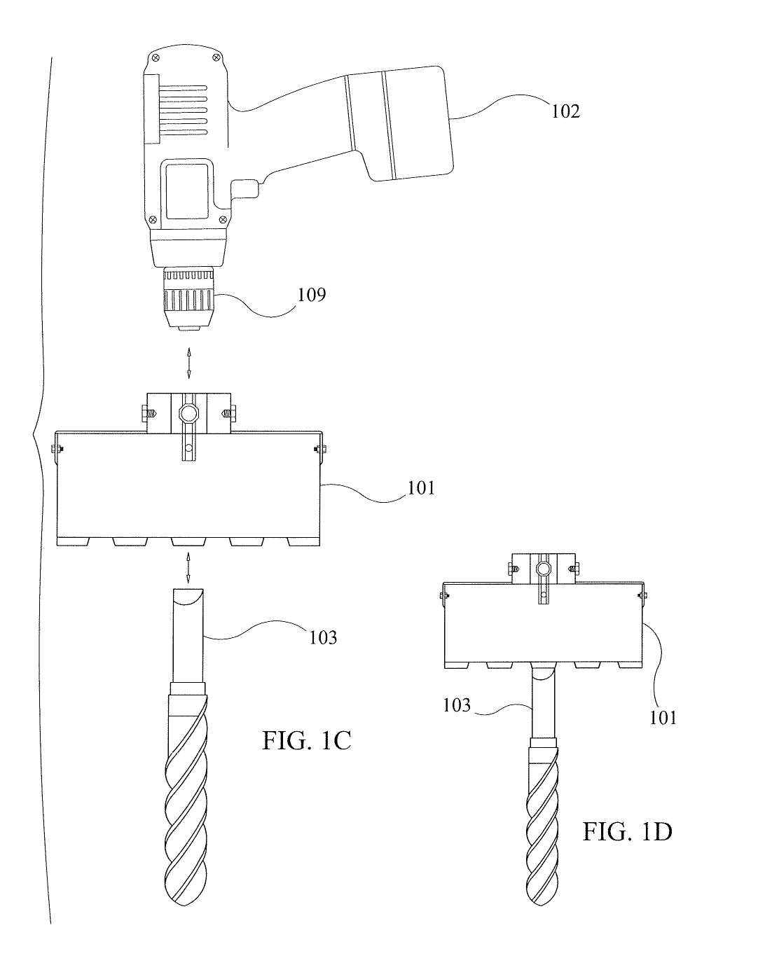

FIG. 1A shows a side view of a second stage drill bit according to an exemplary embodiment of the present invention. FIG. 1B shows a side view of the second stage drill bit detachably coupling to a core drilling machine and a core drill bit according to an exemplary embodiment of the present invention. FIG. 1C shows a side view of the second stage drill bit detachably coupling to a standard drilling device and a standard drill bit according to an exemplary embodiment of the present invention. FIG. 1D shows a side view of the second stage drill bit detachably coupled to a standard drill bit.

Referring to FIGS. 1A to 1D, the second stage drill bit 101 is configured to detachably couple to the drilling device 102 and the primary drill bit 103. The drilling device 102 may be any type of drilling device including, for example, a core drilling machine as shown in FIG. 1B, including a core drilling machine that utilizes a water tank 113 supplying water at a certain pressure to decrease temperature and aid in penetration during the drilling process, and a standard handheld drilling device as shown in FIG. 1C. Similarly, the primary drill bit 103 may be any type of drill bit including, for example, a standard core drill bit as shown in FIG. 1B and a standard drill bit for a handheld drilling device as shown in FIG. 1C. Accordingly, the size of the second stage drill bit 101 may vary according to the type of drilling device 102 it is being utilized with, as well as the size of the holes being drilled.

The second stage drill bit 101 includes a connection adapter 104 disposed at an upper portion thereof, and a main body 107. As used herein, the main body 107 may refer to the entirety of the second stage drill bit 101 other than the connection adapter 104. According to exemplary embodiments, the main body 107 may collectively refer to a bit carrier component 110 of the second stage drill bit 101 and a detachable second stage cutting component 111 (which includes a plurality of teeth 108) of the second stage drill bit 101, as described in further detail below. Alternatively, the main body 107 may correspond to a single element including the bit carrier component 110 and a non-detachable second stage cutting component 111, as described in further detail below.

The size of the main body 107 (e.g., the diameter (e.g., the cutting diameter) of the main body 107), including the size of the second stage cutting component 111, may be larger than the size of the primary drill bit 103 (e.g., the diameter (e.g., the cutting diameter) of the primary drill bit). The second stage drill bit 101 allows for the drilling device 102 and the primary drill bit 103 to be detachably coupled thereto via the connection adapter 104. The detachable coupling of the drilling device 102 and the primary drill bit 103 to the second stage drill bit 101 is described in further detail below.

The drilling device 102 may be any type of standard commonly used drilling device, including both large scale drilling machines and handheld drilling devices. For example, the drilling device 102 may be, but is not limited to, a MILWAUKEE drilling device, a DEWALT drilling device, a HILTI drilling device, etc. Similarly, the primary drill bit 103 may be any type of standard commonly used drill bit. Herein, the drilling device 102, the second stage drill bit 101, and the primary drill bit 103 may be collectively referred to as a coupled drilling device when all three elements are coupled to each other.

Utilization of the second stage drill bit 101 allows for a standard drilling device 102 to be converted to a device capable of drilling a plurality of holes (e.g., two holes), including holes having different sizes, using a single core drilling process. Herein, a single core drilling process refers to a drilling process in which a plurality of holes (e.g., two holes), including holes having different sizes, are drilled into a surface without the need to remove the coupled drilling device from the surface being drilled into while the different holes are being formed, and without the need to manually change drill bits on the coupled drilling device to drill the plurality of holes.

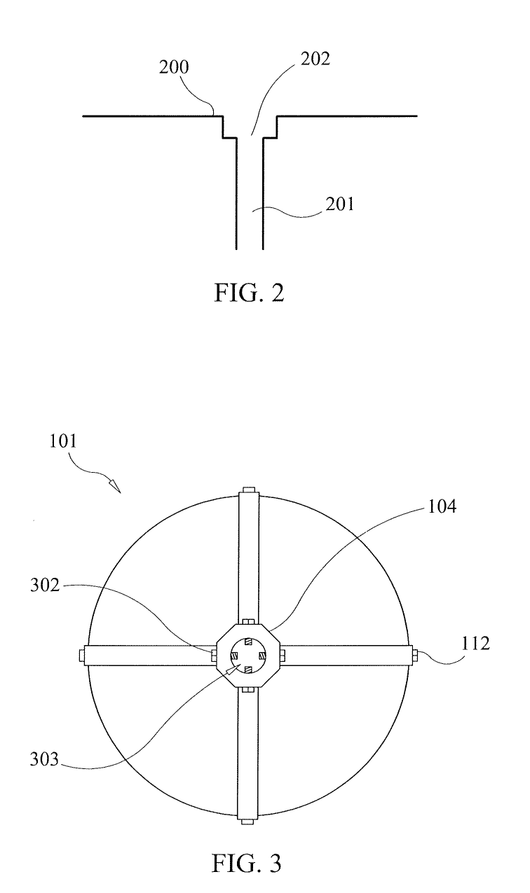

FIG. 2 is a side view showing a core hole drilled using the second stage drill bit shown in FIGS. 1A to 1D according to an exemplary embodiment of the present invention.

As shown in FIG. 2, the second stage drill bit 101 may be used to drill a core hole including a primary hole 201 and a secondary hole 202 into a surface 200. In an exemplary plumbing scenario, the purpose of the primary hole 201 is to accommodate a pipe and the purpose of the secondary hole 202 is to accommodate a connecting portion at the end of the pipe (e.g., a portion of the pipe larger than the majority of the pipe) disposed near the surface 200 into which the pipe is being installed (e.g., the ground, a floor, a wall, etc.). The primary hole 201 and the secondary hole 202 have different sizes. For example, the diameter and/or depth of the primary hole 201 and the diameter and/or depth of the secondary hole 202 may be different from each other. The size (e.g., the diameter and/or depth) of the primary hole 201 may be chosen based on the diameter and length of the pipe being installed, and the size (e.g., the diameter and/or depth) of the secondary hole 202 may be chosen based on the diameter and length of the connection portion at the end of the pipe. Accordingly, different sized second stage drill bits 101 and different sized primary drill bits 103 may be utilized together to drill holes having different desired sizes.

For example, in the exemplary plumbing scenario described above, when drilling the core hole, it may be desired that the primary hole 201 of the core hole have a diameter between about 4 inches and about 6 inches to accommodate the pipe, and the secondary hole 202 of the core hole have a diameter between about 7 inches and about 9 inches to accommodate the connection portion of the pipe. Accordingly, in an exemplary embodiment, the primary drill bit 103, which forms the primary hole 201, may have a cutting diameter between about 4 inches and about 6 inches, and the second stage drill bit 101, which forms the secondary hole 202, may have a cutting diameter between about 7 inches and about 9 inches. It is to be understood that the cutting diameters of the primary drill bit 103 and the second stage drill bit 101 described herein are exemplary, and that the cutting diameters of the primary drill bit 103 and the second stage drill bit 101 may be modified based on the desired size of the primary hole 201 and secondary hole 202. Indeed, as described above, the size of the second stage drill bit 101 may be varied greatly in accordance with the type of drilling device 102 and the type of primary drill bit 103 it is being utilized with, as well as the desired sizes of the primary hole 201 and the secondary hole 202.

Drilling a core hole including two different sized holes using conventional drilling devices typically requires at least two separate drilling processes to be performed. For example, referring to the exemplary plumbing scenario described above, when using conventional drilling devices, a first drill bit having a diameter between about 4 inches and about 6 inches may be coupled to a conventional drilling device and used to drill a first hole (e.g., the primary hole 201 shown in FIG. 2). Then, once drilling of the first hole is complete, the first drill bit may be removed from the drilling device and replaced with a second drill bit having a diameter between about 7 inches and about 9 inches. A second hole (e.g., the secondary hole 202 shown in FIG. 2) overlapping the first hole may then be drilled. Thus, as can be seen, utilization of conventional drilling devices to drill a core hole including two different sized holes may require two separate drilling processes—a first drilling process to drill the first hole having a first size and a second drilling process to drill the second hole having a second size, different from the first size.

According to exemplary embodiments of the present invention, a core hole including a plurality of different sized holes (e.g., two holes) may be drilled using a single drilling process. Further, according to exemplary embodiments, the core hole including the plurality of different sized holes may be drilled using standard, conventional drilling devices 102 and drill bits 103 by detachably coupling the second stage drill bit 101 thereto.

Referring again to FIGS. 1A to 1D, the second stage drill bit 101 is detachably coupled to the drilling device 102 and the primary drill bit 103 in a configuration in which the second stage drill bit 101 is disposed in an area between the drilling device 102 and the primary drill bit 103, and such that a portion of the second stage drill bit 101 surrounds/encloses a portion of the primary drill bit 103 as shown, for example, in FIG. 1D. The detachable coupling of the second stage drill bit 101 to each of the drilling device 102 and the primary drill bit 103 is described in further detail below.

As the drilling device 102 is operated, the primary drill bit 103 is the first part of the coupled drilling device to make contact with the surface being drilled into (e.g., the surface 200 shown in FIG. 2) (hereinafter referred to as the “target surface”). The primary drill bit 103 forms the primary hole 201 shown in FIG. 2. As the primary drill bit 103 penetrates the target surface, the distance between the second stage drill bit 101 and the target surface decreases until the bottom edge 106 of the second stage drill bit 101 makes contact with the target surface. As operation of the drilling device 102 continues, the second stage drill bit 101 penetrates the target surface, forming the secondary hole 202 shown in FIG. 2. Thus, according to exemplary embodiments of the present invention, a core hole including a primary hole 201 and a secondary hole 202 may be drilled using a single drilling process.

The bottom edge 106 of the second stage drill bit 101 includes a plurality of teeth 108 that penetrate the target surface during drilling. The teeth may be formed of any of the materials described above as forming the second stage drill bit 101, and may be, for example, diamond encrusted teeth. The spacing between the teeth may vary, and as a result, the surface area of the bottom edge 106 covered by the teeth may vary. For example, in an exemplary embodiment, there may be a space of about 2 inches between each of the teeth 108 and about 40 percent of the bottom edge 106 may be covered by the teeth 108, however exemplary embodiments are not limited thereto. The material used for the teeth 108 and/or the spacing between the teeth 108 and coverage of the teeth 108 on the bottom edge 106 may vary depending on the intended target surface, and are not limited to the examples provided above.

The ability to drill a core hole having two different sized holes using a single drilling process according to exemplary embodiments of the present invention instead of, for example, drilling a core hole having two different sized holes using two or more separate drilling processes, results in an overall improved drilling process. For example, according to exemplary embodiments, since the second stage drill bit 101 allows for the primary hole 201 and the secondary hole 202 to be drilled in a single drilling process, the speed at which the core hole including the primary hole 201 and the secondary hole 202 is drilled may be increased, since there is no need to change drill bits to obtain each different sized hole. In addition, since the primary drill bit 103 is not removed during the drilling process according to exemplary embodiments, the coupled drilling device remains fixed at its original position during drilling of both the primary hole 201 and the secondary hole 202. As a result, alignment during the drilling process is automatic, and the drill operator is not required to perform manual alignment when changing drill bits. Thus, exemplary embodiments of the present invention may provide for a faster, more efficient, and more accurate drilling process.

Further, because the second stage drill bit 101 is configured to attach to any standard, conventional drilling device 102 and any standard, conventional primary drill bit 103, the drilling operator is not forced to use a proprietary drilling device. Rather, the drilling operator may use any existing commonly used drilling device 102 and primary drill bit 103 with the second stage drill bit 101. As a result, the second stage drill bit 101 according to exemplary embodiments of the present invention allows for any existing drilling device 102 and primary drill bit 103 to be utilized to perform a single drilling process capable of drilling a plurality of holes having different sizes.

FIG. 3 is a top view of the second stage drill bit shown in FIGS. 1A to 1D according to an exemplary embodiment of the present invention.

Referring to FIGS. 1A to 1D and FIG. 3, the connection adapter 104 of the second stage drill bit 101 allows for the drilling device 102 and the primary drill bit 103 to be detachably coupled to the second stage drill bit 101. As described above, the connection adapter 104 allows for the detachable coupling of any one of a variety of commonly used drilling devices 102 including, for example, a MILWAUKEE drilling device, a DEWALT drilling device, a HILTI drilling device, etc., and for the detachable coupling of any commonly used primary drill bit 103, to the second stage drill bit 101.

According to an exemplary embodiment, the connection adapter 104 is integrally formed with the main body 107 of the second stage drill bit 101. For example, in an exemplary embodiment, the connection adapter 104 and the main body 107, including the bit carrier component 110 and the second stage cutting component 111, are part of a single element and are not detachable from each other (e.g., the components may be welded together). Alternatively, in an exemplary embodiment, the connection adapter 104 may be integrally formed with the bit carrier component 110, and the second stage cutting component 111 may be detachably coupled to the bit carrier component 110 via, for example, a plurality of attachment screws 112 extending through the bit carrier component 110 and into the second stage cutting component 111. That is, the bit carrier component 110 may be permanently coupled to the connection adapter 104 (e.g., the components may be welded together), and the second stage cutting component 111 may be detachably coupled to the bit carrier component 110. As a result, the second stage cutting component 111 may be replaced when necessary (e.g., when worn out) without having to also replace the rest of the second stage drill bit 101.

The connection adapter 104 is configured to be detachably coupled to the drilling device 102 via a variety of different connection schemes, allowing the second stage drill bit 101 to be detachably coupled to and used with a variety of commonly used drilling devices 102, as described above. In addition, the connection adapter 104 is configured to be detachably coupled to a variety of commonly used primary drill bits 103.

Referring to the detachable coupling of the connection adapter 104 to the primary drill bit 103, the connection adapter 104 includes a plurality of set screws 302 (e.g., two or more set screws 302). The number of set screws 302 may vary according to the size of the second stage drill bit 101 and/or the size of the primary drill bit 103. For example, in an exemplary embodiment, the connection adapter 104 includes four set screws 302, however, the number of set screws 302 is not limited thereto. The plurality of set screws 302 extend through a sidewall of the connection adapter 104 and into an inner chamber 303 of the connection adapter 104. The inner chamber 303 is shaped and dimensioned to receive the primary drill bit 103 (e.g., the shank of the primary drill bit 103) through the main body 107 (see, for example, FIGS. 1B to 1D). The inner chamber 303 may be shaped and dimensioned to receive a variety of different primary drill bits 103. For example, the inner chamber 303 may be shaped and dimensioned to receive a primary drill bit 103 having different sizes and different shapes including, for example, a straight shank, a hex shank, an SDS shank, a triangle shank, a morse taper shank, a square shank, a brace shank, etc. In exemplary embodiments, a different number of set screws 302 may be utilized to detachably couple the connection adapter 104 to different types of drill bit shanks.

Once the primary drill bit 103 has been received through the main body 107 of the second stage drill bit 101 and into the inner chamber 303 of the connection adapter 104, the set screws 302 are tightened such that they contact the primary drill bit 103 (e.g., the shank of the primary drill bit 103). Tightening the set screws 302 using a sufficient amount of force detachably couples the primary drill bit 103 to the connection adapter 104 in a secure manner.

Once the primary drill bit 103 has been detachably coupled to the second stage drill bit 101 via the connection adapter 104, the second stage drill bit 101 is detachably coupled to the drilling device 102 via the connection adapter 104. The detachable coupling between the connection adapter 104 and the drilling device 102 may be implemented in a variety of manners depending on the type of drilling device 102 being utilized with the second stage drill bit 101. Thus, the second stage drill bit 101 may be detachably coupled to a variety of standard drilling devices including drilling devices that utilize a threaded drill bit attachment scheme, a non-threaded drill bit attachment scheme, and proprietary adapters to connect the drill bit to the drilling device (e.g., a HILTI adapter utilized with a HILTI drilling device).

Referring to the detachable coupling of the connection adapter 104 to the drilling device 102, in an exemplary embodiment, the inner chamber 303 of the connection adapter 104 may be shaped and dimensioned to function as a pass-through aperture 303 that permits the drill bit connecting portion of the drilling device 102 (e.g., the portion of the drilling device 102 that normally connects to the primary drill bit 103) to extend through the inner chamber 303 and attach to the primary drill bit 103 through the connection adapter 104. That is, the inner chamber 303 may also be referred to herein as a pass-through aperture 303 configured to permit the drill bit connecting portion of the drilling device 102 to extend through the connection adapter 104 and detachably couple/directly connect to the primary drill bit 103. For example, referring to a drilling device 102 that utilizes a threaded drill bit attachment scheme, the connecting portion of the drilling device 102 may directly attach to the primary drill bit 103 through the connection adapter 104 via cooperating threaded connections respectively disposed on the connecting portion of the drilling device 102 and the primary drill bit 103 (e.g., the primary drill bit 103 may include a threaded connection disposed on an inner wall of a shank of the primary drill bit 103). For example, the primary drill bit 103 may extend through the main body 107 of the second stage drill bit 101, detachably couple to the second stage drill big 101 via the connection adapter 104 as described above, and be screwed onto the connecting portion of the drilling device 102 through the pass-through aperture 303.

Referring to the detachable coupling of the second stage drill bit 101 with a drilling device 102, in an exemplary embodiment, the connecting portion of the drilling device 102 may be a chuck 109, which may include jaws arranged in a radially symmetrical pattern to grasp a drill bit (e.g., a shank of the drill bit) inserted thereto, and which may be opened, for example, by turning the chuck 109 in a first direction. Rather than inserting a standard drill bit such as the primary drill bit 103 into the opened chuck 109, the connection adapter 104 of the second stage drill bit 101, which is already attached to the connection adapter 104, may be shaped and dimensioned to be inserted into the opened chuck 109. The chuck 109 may then be tightened around the connection adapter 104, for example, by turning the chuck 109 in a second direction opposite to the first direction, to detachably couple the second stage drill bit 101 to the drilling device 102. The connection adapter 104 may have one of a variety of shapes to permit detachable coupling to the chuck 109 of the drilling device 102. For example, the connection adapter 104 may have a shape corresponding to, for example, a substantially cylindrical shape, a straight shank, a hex shank, an SDS shank, a triangle shank, a morse taper shank, a square shank, or a brace shank. However, the shape of the connection adapter 104 is not limited thereto.

Referring to the detachable coupling of the second stage drill bit 101 with a drilling device 102, in an exemplary embodiment, the connection adapter 104 may include a threaded portion disposed on a sidewall of the connection adapter 104. According to exemplary embodiments, the threaded portion may be disposed on an inner surface of the sidewall (e.g., the surface facing the inner chamber 303) and/or on an outer surface of the sidewall.

In an exemplary embodiment in which the threaded portion is disposed on the inner surface of the sidewall of the connection adapter 104, a threaded adapter of the drilling device 102 may be received into the inner chamber 303 of the connection adapter 104. The threaded adapter of the drilling device 102 may be, for example, an integral part of the drilling device 102, or may be a separate adapter configured to be attached to the drilling device 102. The threaded portion of the connection adapter 104 includes, for example, a thread pattern that interlocks with the threaded adapter of the drilling device 102 (e.g., upon being tightened by turning the second stage drill bit 101) to detachably couple the second stage drill bit 101 to the drilling device 102.

In an exemplary embodiment in which the threaded portion is disposed on the outer surface of the sidewall of the connection adapter 104, the connection adapter 104 may be detachably coupled to a drilling device 102 that utilizes a threaded drill bit attachment mechanism by inserting the connection adapter 104 into a threaded adapter of the drilling device 102 and tightening the second stage drill bit 101 around the threaded adapter of the drilling device by turning the second stage drill bit 101. When the threaded portion is disposed on the outer surface of the sidewall of the connection adapter 102, the set screws 302 may be disposed within recesses of the connection adapter 104 allowing for the thread pattern of the threaded portion to interlock with the threaded adapter of the drilling device 102.

According to exemplary embodiments, the threaded portion may be disposed on either the inner or outer surface of the sidewall of the connection adapter 104, or on both the inner and outer surface of the sidewall of the connection adapter 104. In addition, the area of the threaded portion of the connection adapter 104 may cover an entirety of the surface(s) it is disposed on, or a portion of the surface(s) it is disposed on. In an exemplary embodiment, the threaded portion may extend from an upper portion of the connection adapter 104 to the set screws 302 of the connection adapter 104.

While the present invention has been particularly shown and described with reference to the exemplary embodiments thereof, it will be understood by those of ordinary skill in the art that various changes in form and detail may be made therein without departing from the spirit and scope of the present invention as defined by the following claims.

What is claimed is:

1. A second stage drill bit, comprising:
a main body;
a connection adapter disposed on an upper portion of the main body, wherein the connection adapter is configured to detachably couple the second stage drill bit to a drilling device and to detachably couple the second stage drill bit to a primary drill bit; and
a plurality of teeth disposed on a bottom edge of the main body, wherein the plurality of teeth are configured to penetrate a surface during a drilling process,
wherein upon coupling the second stage drill bit to the drilling device and the primary drill bit, the second stage drill bit is disposed in an area between the drilling device and the primary drill bit, and a portion of the primary drill bit is surrounded by the main body.

2. The second stage drill bit of claim 1, wherein a size of the main body is larger than a size of the primary drill bit.

3. The second stage drill bit of claim 2, wherein the size of the main body corresponds to a diameter of the main body and a size of the primary drill bit corresponds to a diameter of the primary drill bit.

4. The second stage drill bit of claim 1, wherein the connection adapter comprises:
a plurality of set screws extending through a sidewall of the connection adapter and into an inner chamber of the connection adapter,
wherein the inner chamber is shaped and dimensioned to receive the primary drill bit through the main body, and the plurality of set screws detachably couple the second stage drill bit to the primary drill bit upon the plurality of set screws contacting the primary drill bit in the inner chamber in response to being tightened.

5. The second stage drill bit of claim 1, wherein the connection adapter comprises a pass-through aperture configured to permit a drill bit connecting portion of the drilling device to extend through the pass-through aperture and detachably couple to the primary drill bit through the connection adapter.

6. The second stage drill bit of claim 5, wherein the drill bit connecting portion of the drilling device detachably couples to the primary drill bit through the connection adapter via cooperating threaded connections respectively disposed on the connection portion of the drilling device and the primary drill bit.

7. The second stage drill bit if claim 1, wherein the connection adapter is shaped and dimensioned to be received into a chuck of the drilling device to detachably couple the second stage drill bit to the drilling device.

8. The second stage drill bit of claim 1, wherein the connection adapter comprises:
a threaded portion disposed on an inner sidewall of the connection adapter facing an inner chamber of the connection adapter,
wherein the inner chamber is shaped and dimensioned to receive a threaded adapter connected to the drilling device, and the threaded portion of the connection adapter comprises a thread pattern that interlocks with the threaded adapter to detachably couple the second stage drill bit to the drilling device.

9. The second stage drill bit of claim 1, wherein the drilling device is a large scale drilling machine.

10. The second stage drill bit of claim 1, wherein the drilling device is a handheld drilling device.

11. A second stage drill bit, comprising:
a connection adapter disposed at an upper portion of the second stage drill bit, wherein the connection adapter is configured to detachably couple the second stage drill bit to a drilling device and to detachably couple the second stage drill bit to a primary drill bit;
a bit carrier component coupled to the connection adapter; and
a second stage cutting component coupled to the bit carrier component, wherein the second stage cutting component comprises a plurality of teeth disposed on a bottom edge of the second stage cutting component and the plurality of teeth are configured to penetrate a surface during a drilling process,
wherein upon coupling the second stage drill bit to the drilling device and the primary drill bit, the second stage drill bit is disposed in an area between the drilling device and the primary drill bit, and a portion of the primary drill bit is surrounded by a portion of the second stage drill bit.

12. The second stage drill bit of claim 11, wherein a size of the second stage cutting component is larger than a size of the primary drill bit.

13. The second stage drill bit of claim 12, wherein the size of the second stage cutting component corresponds to a diameter of the second stage cutting component and a size of the primary drill bit corresponds to a diameter of the primary drill bit.

14. The second stage drill bit of claim 11, wherein the connection adapter comprises:
a plurality of set screws extending through a sidewall of the connection adapter and into an inner chamber of the connection adapter,
wherein the inner chamber is shaped and dimensioned to receive the primary drill bit, and the plurality of set screws detachably couple the second stage drill bit to the primary drill bit upon the plurality of set screws contacting the primary drill bit in the inner chamber in response to being tightened.

15. The second stage drill bit of claim 11, wherein the connection adapter comprises a pass-through aperture configured to permit a drill bit connecting portion of the drilling device to extend through the pass-through aperture and detachably couple to the primary drill bit through the connection adapter.

16. The second stage drill bit of claim 15, wherein the drill bit connecting portion of the drilling device detachably couples to the primary drill bit through the connection adapter via cooperating threaded connections respectively disposed on the connection portion of the drilling device and the primary drill bit.

17. The second stage drill bit of claim 11, wherein the bit carrier component is permanently coupled to the connection adapter, and the second stage cutting component is detachably coupled to the bit carrier component.

18. The second stage drill bit of claim 11, wherein the connection adapter is shaped and dimensioned to be received into a chuck of the drilling device to detachably couple the second stage drill bit to the drilling device.

19. The second stage drill bit of claim 11, wherein the connection adapter comprises:
a threaded portion disposed on an inner sidewall of the connection adapter facing an inner chamber of the connection adapter,
wherein the inner chamber is shaped and dimensioned to receive a threaded adapter connected to the drilling device, and the threaded portion of the connection adapter comprises a thread pattern that interlocks with the threaded adapter to detachably couple the second stage drill bit to the drilling device.

20. A second stage drill bit, comprising:
a connection adapter disposed at an upper portion of the second stage drill bit, wherein the connection adapter is configured to detachably couple the second stage drill bit to a drilling device and to detachably couple the second stage drill bit to a primary drill bit,
wherein the connection adapter comprises:
a plurality of set screws extending through a sidewall of the connection adapter and into an inner chamber of the connection adapter,
wherein the inner chamber is shaped and dimensioned to receive the primary drill bit through the main body, and the plurality of set screws detachably couple the second stage drill bit to the primary drill bit upon the plurality of set screws contacting the primary drill bit in the inner chamber in response to being tightened,
wherein the inner chamber forms a pass-through aperture configured to permit a drill bit connecting portion of the drilling device to extend through the pass-through aperture and detachably couple to the primary drill bit through the connection adapter;
a bit carrier component permanently coupled to the connection adapter; and
a second stage cutting component detachably coupled to the bit carrier component, wherein the second stage cutting component comprises a plurality of teeth disposed on a bottom edge of the second stage cutting component and the plurality of teeth are configured to penetrate a surface during a drilling process,
wherein upon coupling the second stage drill bit to the drilling device and the primary drill bit, the second stage drill bit is disposed in an area between the drilling device and the primary drill bit, and a portion of the primary drill bit is surrounded by a portion of the second stage drill bit.
